(19) United States
(12) Patent Application Publication
(10) Pub. No.: US 2013/0207949 A1
(43) Pub. Date: Aug. 15, 2013

(54) DISPLAY DEVICE AND METHOD FOR ADJUSTING BRIGHTNESS OF THE DISPLAY DEVICE

(71) Applicants: TIE-ZHENG JIANG, Shenzhen (CN); CHI-CHE CHEN, Tu-Cheng (TW)

(72) Inventors: TIE-ZHENG JIANG, Shenzhen (CN); CHI-CHE CHEN, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/526,590

(22) Filed: Jun. 19, 2012

(30) Foreign Application Priority Data
Feb. 15, 2012 (CN) 201210033943.5

(51) Int. Cl. G09G 5/02; G06F 3/038

(52) U.S. Cl. 345/207

(57) ABSTRACT

A method for adjusting brightness of a display device acquires optical signals from a plurality of light sensors positioned on the display device. The optical signals are converted into digital signals. An ambient brightness value is determined according to the digital signals. If the ambient brightness value is not less than a predetermined value, a calibration brightness value of the display device is calculated according to the ambient brightness value. If the calibration brightness value is equal to zero and the display device has received video signals during a predetermined time interval, a current brightness value of the display device is maintained. If the calibration brightness value is not equal to zero and the display device has received the video signals during the predetermined time interval, the current brightness value of the display device is adjusted according to the calibration brightness value.

### BACKGROUND

1. Technical Field

Embodiments of the present disclosure relate to brightness adjustment technology, and particularly to a display device and method for adjusting brightness of the display device.

2. Description of Related Art

Electronic devices have display devices for people to input or output relevant data. The display device may be a liquid crystal display (LCD) or a touch panel, for example. The display device may provide a manual adjustment function and an automatic adjustment function for the adjustment of the brightness of the display device. If ambient brightness of the display device changes suddenly while people are looking at the display device, it will make people's eyes feel uncomfortable. However, it is not efficient and convenient for people to adjust the brightness of the display device manually, and the automatic adjustment function may change the brightness of the display device to predetermined settings. That is, some display devices cannot change the display brightness according to changes of ambient brightness automatically by using the automatic adjustment function. Therefore, an efficient method for adjusting the brightness of the display device according to changes of the ambient brightness automatically is desired.

### BRIEF DESCRIPTION OF THE DRAWINGS

FIG. 1 is a block diagram of one embodiment of a display device including a brightness adjustment system.

FIG. 2 is a block diagram of one embodiment of the brightness adjustment system of the display device FIG. 1.

FIG. 3 is a block diagram of one embodiment of different elements in the display device to adjust brightness of the display device of FIG. 1.

FIGS. 4A, 4B and 4C are flowcharts of one embodiment of a method for adjusting brightness of the display device using the brightness adjustment system of FIG. 2.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

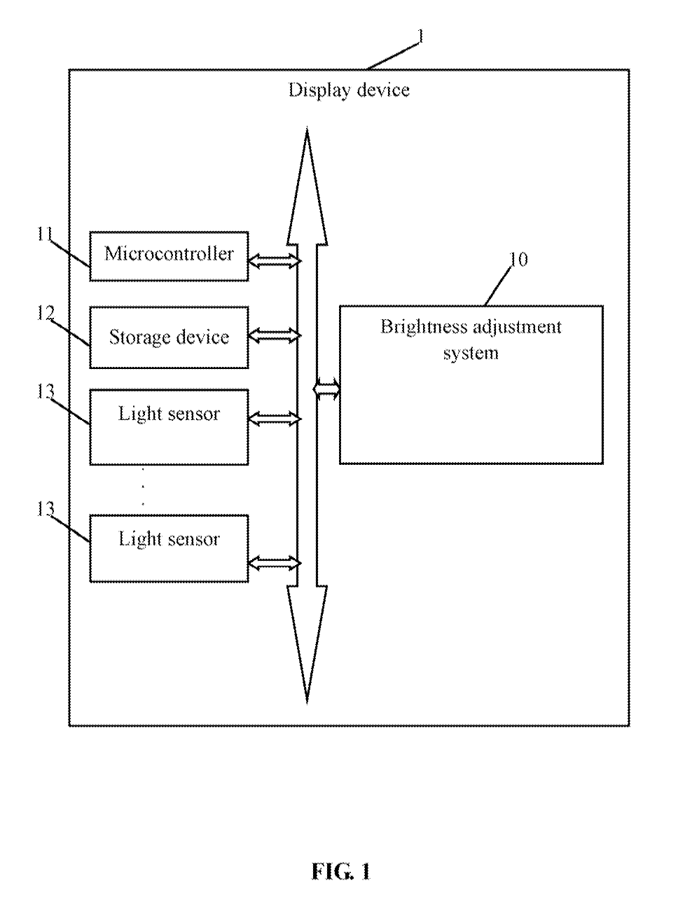

FIG. 1 is a block diagram of one embodiment of a display device 1 including a brightness adjustment system 10. The display device 1 may be a liquid crystal display (LCD), a touch-sensitive display, or any other display device of different kinds of electronic device, such as a cell phone, a personal digital assistant, a tablet computer, a notebook computer, a television (TV), or other computing device. The display device 1 may be connected to one of the electronic devices, or be installed on or embedded in one of the electronic devices.

In some embodiments, the brightness adjustment system 10 detects an ambient brightness value of the display device 1, calculates a calibration brightness value according to the ambient brightness, and adjusts a current brightness value of the display device 1 using the calibration brightness value when the display device 1 matches predetermined conditions. A detailed description of brightness adjustment system 10 will be given in the following paragraphs.

The display device 1 further includes at least one microcontroller 11, a storage device 12, and a plurality of light sensors 13 (only two are shown in FIG. 1). FIG. 1 illustrates only one example of the display device 1 that may include more or fewer components than illustrated, or have a different configuration of the various components. In some embodiments, the light sensors 13 are installed or located on different positions of the display device 1, to detect optical signals (e.g., analog signals) of ambient brightness of the display device 1 and determine light level(s). The brightness adjustment system 10 may acquire the optical signals from the light sensors 13 to determine an ambient brightness of the display device 1.

The storage device 12 provides one or more memory functions. In one embodiment, brightness adjustment system 10 may include computerized instructions in the form of one or more programs that are executed by the at least one microcontroller 11 and stored in the storage device 12. The storage device 12 stores one or more programs, such as program codes of the brightness adjustment system 10, other applications of the display device 1, and various kinds of data, such as adjustment parameters. In some embodiments, the storage device 12 may include a memory of the display device 1 and/or a non-volatile memory, such as a programmable read-only memory (PROM), an Electrically Erasable Programmable Read-Only Memory (EEPROM), a flash memory, or any other type of memory device.

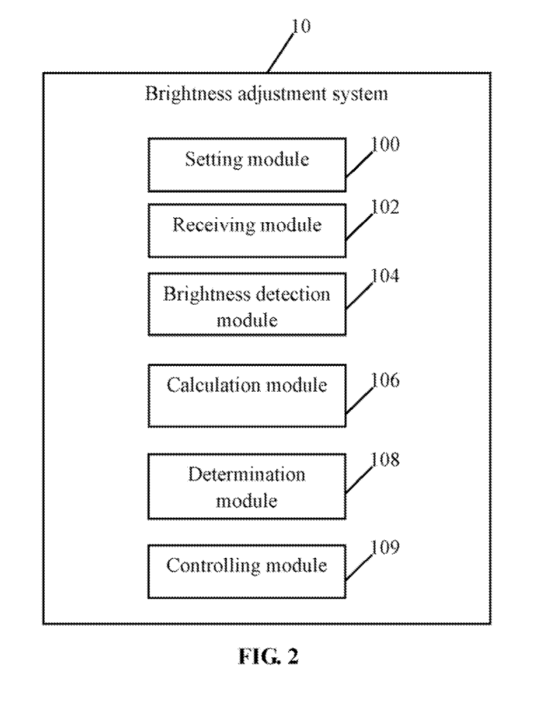

FIG. 2 is a block diagram of one embodiment of the brightness adjustment system 10 of the display device 1 FIG. 1. In one embodiment, the brightness adjustment system 10 may include one or more modules, for example, a setting module 100, a receiving module 102, a brightness detection module 104, a calculation module 106, a determination module 108, and a controlling module 109. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The setting module 100 presets relevant parameters and record the preset parameters in the storage device 12. Detailed descriptions on the parameters are introduced below.

As mentioned above, the light sensors 13 detect the optical signals of ambient brightness of a current environment of the display device 1, determine light level(s) based on the optical signals. The optical signals are analog signals. The receiving module 102 acquires the optical signals from the light sensors 13, and converts the optical signals into digital signals. For example, the receiving module 102 may include an analog-to-digital converter (ADC) to convert the electrical signals to the digital signals. In other embodiments, the light sensors 13 may convert the optical signals into electrical signals, the electrical signals are analog signals. Then the receiving module 102 converts the analog signals (e.g., the electrical signals) into the digital signals.

The brightness detection module 104 determines an ambient brightness value of the display device 1 and a light level of the ambient brightness according to the digital signals.

The determination module 108 compares the ambient brightness value with a predetermined value preset by the setting module 100, and determines whether the ambient brightness value is less than the predetermined value. For example, the predetermined value may be 10 lux. The setting module 100 may modify the predetermined value according to user requirements.

If the ambient brightness value is not less than the predetermined value, the calculation module 106 calculates a calibration brightness value of the display device 1 corresponding to the ambient brightness value using a predetermined mapping function. In some embodiments, the calibration brightness value is regarded as a better brightness value of the display device 1 based on the ambient brightness value, which is appropriate for viewer comfort. The predetermined mapping function is provided as below:

$$f ( x ) = \{ \begin{matrix}9.9323 Inx + 27.059 , x < 1254 \\ 100 , x \geq 1254.\end{matrix}$$

In the predetermined mapping function, “f(x)” represents the calibration brightness value, “x” represents the ambient brightness value, and “In(x)” represents a natural logarithm of “x”. The natural logarithm is the logarithm to the base “e”, where “e” is an irrational and transcendental constant approximately equal to 2.718281828.

If the ambient brightness value is less than the predetermined value, the calculation module 106 determines the calibration brightness value to be zero, and determines that there is no need to adjust a current brightness value of the display device 1. In some embodiments, the predetermined value may be preset according to a low level lighting of indoor lighting. It is determined that the display device 1 is in an environment having a low level lighting or in a dark environment, when the ambient brightness value is less than the predetermined value. Then it is determined that there is no need to adjust the current brightness value of the display device 1, and the calibration brightness value is determined to be zero correspondingly.

The determination module 108 further determines whether the display device 1 has received any video signals during a predetermined time interval preset by the setting module 100. The predetermined time interval may be 1 minute for example. In some embodiments, the video signals may be sent to the display device 1 from the electronic device or any other device connected with the display device 1.

If the calibration brightness value is equal to zero and the display device 1 has received video signals during the predetermined time interval, the controlling module 109 maintains the current brightness value of the display device 1. That is, the controlling module 109 does not adjust the current brightness value of the display device 1.

If the calibration brightness value is not equal to zero and the display device 1 has received the video signals during the predetermined time interval, the controlling module 109 adjusts the current brightness value of the display device 1 according to the calibration brightness value. That is, the controlling module 109 changes the current brightness value of the display device 1 to the calibration brightness value.

If the display device 1 has not received any video signals during the predetermined time interval, that is, no matter whether the calibration brightness value is equal to zero, the controlling module 109 shuts off a main circuit of the display device 1.

In other embodiments, the setting module 100 sets operation modes of the display device 1. The operation modes may include, but are not limited to a factory mode, a testing mode, and a working mode. In the factory mode, various parameters of the display device 1 are preset by a manufacturer. In the testing mode, the parameters of the display device 1 can be changed according to test requirements.

The controlling module 109 maintains the current brightness value of the display device 1, and continues receiving the electrical signals from the light sensors 13 without adjusting the current brightness of the display device 1, under the condition that the calibration brightness value is not equal to zero and the display device 1 is in the factory mode or the testing mode.

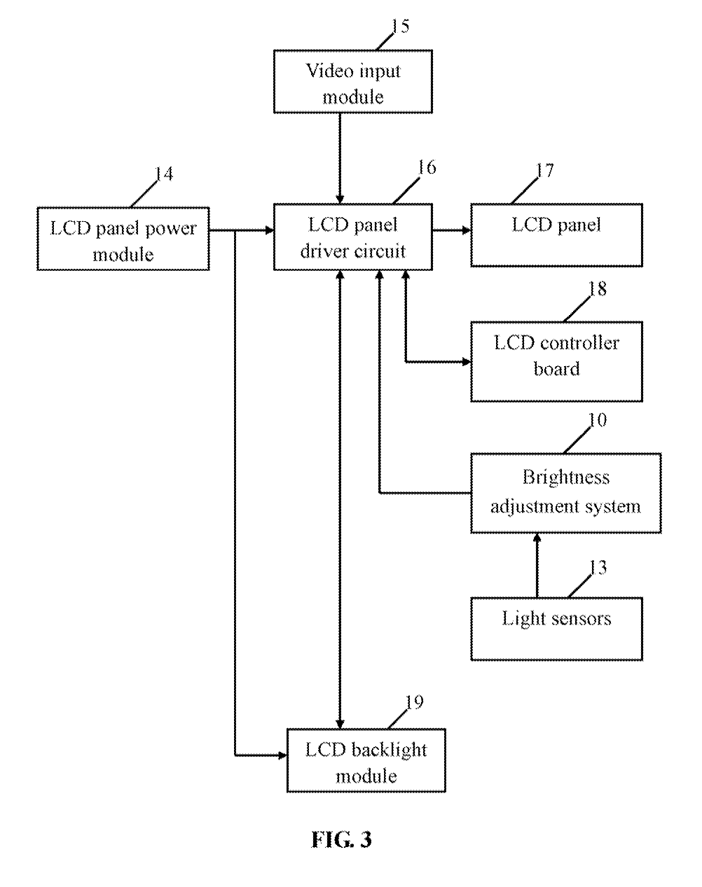

FIG. 3 is a block diagram of one embodiment of different elements in the display device to adjust brightness of the display device of FIG. 1. For simplification, the display device 1 is supposed to be a LCD display in following descriptions of FIG. 3. The display device 1 includes the brightness adjustment system 10, the light sensors 13, a LCD panel power module 14, a video input module 15, a LCD panel driver circuit 16, a LCD panel 17, a LCD controller board 18, and a LCD backlight module 19.

When the display device 1 is powered on, the LCD panel power module 14 converts input voltage from a power supply of the display device 1 to appropriate voltage(s) that are suitable for the LCD panel 17 and the LCD backlight module 19.

The video input module 15 receives the video signals from the electronic device or other device connected to the display device 1, and sends the video signals to the LCD panel driver circuit 16. The LCD panel driver circuit 16 processes the video signals, sends the processed video signals to the LCD panel 17, and sends backlight controlling signals to the LCD backlight module 19. The LCD controller board 18 adjusts various settings according to display parameters, such as brightness, display resolution, contrast, phase, and power saving mode, for example.

The brightness adjustment system 10 receives the electrical signals from the light sensors 13, and calculates the calibration brightness value to adjust the current brightness value of the display device 1. For example, the brightness adjustment system 10 may send the calibration brightness value to the LCD panel driver circuit 16 through the microcontroller 11, for adjusting the current brightness value of the display device 1.

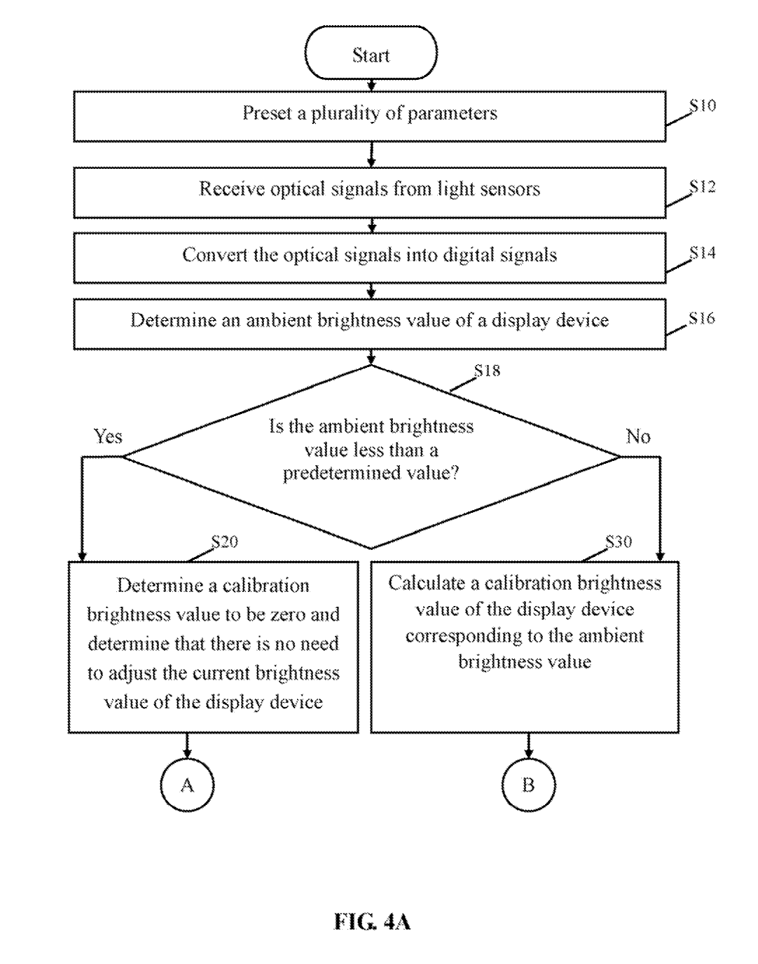

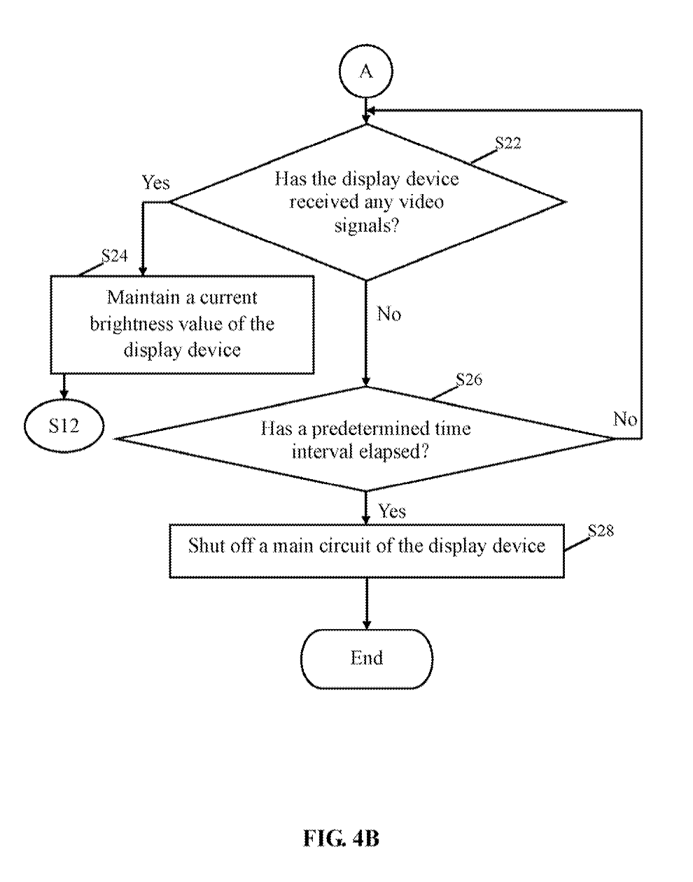

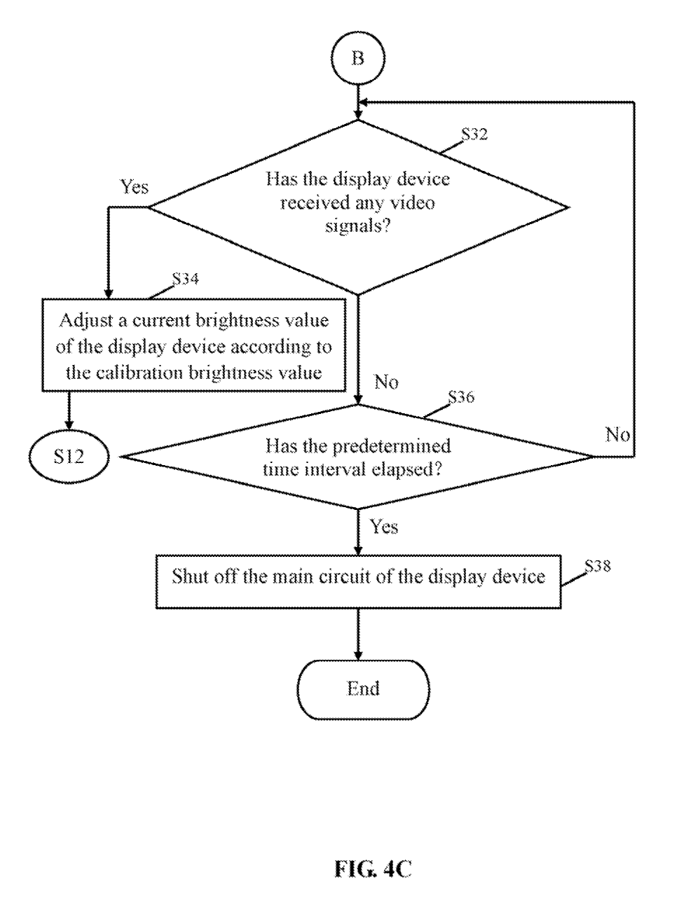

FIGS. 4A, 4B, and 4C are flowcharts of one embodiment of a method for adjusting brightness of the display device 1 using the brightness adjustment system 10 of FIG. 2. Depending on the embodiment, additional steps may be added, others moved, and the ordering of the steps may be changed.

In step S10, the setting module 100 presets relevant parameters, detailed descriptions on the parameters are introduced below.

In step S12, the receiving module 102 acquires optical signals from the light sensors 13. As mentioned above, the light sensors 13 detect the optical signals of ambient brightness of the current environment of the display device 1. The optical signals are analog signals.

In step S14, the receiving module 102 converts the optical signals into digital signals.

In step S16, the brightness detection module 104 determines an ambient brightness value of the display device 1 according to the digital signals.

In step S18, the determination module 108 compares the ambient brightness value with a predetermined value preset by the setting module 100, and determines whether the ambient brightness value is less than the predetermined value. If the ambient brightness value is less than the predetermined value, the procedure goes to step S20. If the ambient brightness value is not less than the predetermined value, the procedure goes to step S30.

If the ambient brightness value is less than the predetermined value, in step S20, the calculation module 106 determines the calibration brightness value to be zero, and determines that there is no need to adjust a current brightness value of the display device 1.

In step S22, the determination module 108 determines whether the display device 1 has received any video signals.

If the display device 1 has received the video signals, in step S24, the controlling module 109 maintains the current brightness value of the display device 1, then the procedure returns to step S12.

If the display device 1 has not received any video signals, in step S26, the determination module 108 determines whether a predetermined time interval preset by the setting module 100 has elapsed. If the predetermined time interval has not elapsed, the procedure returns to step S22.

If the predetermined time interval has elapsed, in step S28, the controlling module 109 shuts off a main circuit of the display device 1, then the procedure ends.

In step S30, the calculation module 106 calculates a calibration brightness value of the display device 1 corresponding to the ambient brightness value using the predetermined mapping function as mentioned above.

In step S32, the determination module 108 determines whether the display device 1 has received any video signals.

If the display device 1 has received the video signals, in step S34, the controlling module 109 adjusts the current brightness value of the display device 1 according to the calibration brightness value, then the procedure returns to step S12.

If the display device 1 has not received any video signals, in step S36, the determination module 108 determines whether the predetermined time interval has elapsed. If the predetermined time interval has not elapsed, the procedure returns to step S32.

If the predetermined time interval has elapsed, in step S38, the controlling module 109 shuts off the main circuit of the display device 1, then the procedure ends.

It should be emphasized that the above-described embodiments of the present disclosure, particularly, any embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure is protected by the following claims.

What is claimed is:

1. A computer-implemented method for adjusting brightness of a display device, the display device comprising a plurality of light sensors, the method comprising execution of the steps comprising:
acquiring optical signals from the plurality of light sensors, the light sensors detecting the optical signals of a current environment of the display device;
converting the optical signals into digital signals;
determining an ambient brightness value of the display device according to the digital signals;
calculating a calibration brightness value of the display device corresponding to the ambient brightness value using a predetermined mapping function, under the condition that the ambient brightness value is not less than a predetermined value; and
maintaining a current brightness value of the display device under the condition that the calibration brightness value is equal to zero and the display device has received video signals during a predetermined time interval; or
adjusting the current brightness value of the display device according to the calibration brightness value, under the condition that the calibration brightness value is not equal to zero and the display device has received the video signals during the predetermined time interval.

2. The method according to claim 1, further comprising:
determining the calibration brightness value to be zero and determining that there is no need to adjust the current brightness value of the display device, under the condition that the ambient brightness value is less than the predetermined value.

3. The method according to claim 1, further comprising:
shutting off a main circuit of the display device, under the condition that the display device has not received any video signals during the predetermined time interval.

4. The method according to claim 1, further comprising:
setting operation modes of the display device, the operation modes comprising a factory mode, a testing mode, and a working mode.

5. The method according to claim 4, further comprising:
maintaining the current brightness value of the display device, and continuing receiving the electrical signals from the plurality of light sensors without adjusting the current brightness of the display device, under the condition that the calibration brightness value is not equal to zero and the display device is in the factory mode or the testing mode.

6. The method according to claim 1, wherein the predetermined mapping function is
$$f ( x ) = \{ \begin{matrix}9.9323 Inx + 27.059 , x < 1254 \\ 100 , x \geq 1254.\end{matrix}$$

7. A display device, comprising:
a plurality of light sensors being located on different positions of the display device;
a storage device;
at least one microcontroller; and
one or more modules that are stored in the storage device and executed by the at least one microcontroller, the one or more modules comprising:
a receiving module that acquires optical signals from the plurality of light sensors, and converts the optical signals into digital signals, the light sensors detecting the optical signals of a current environment of the display device;
a brightness detection module that determines an ambient brightness value of the display device according to the digital signals;
a calculation module that calculates a calibration brightness value of the display device corresponding to the ambient brightness value using a predetermined mapping function, under the condition that the ambient brightness value is not less than a predetermined value; and
a controlling module that maintains a current brightness value of the display device under the condition that the calibration brightness value is equal to zero and the display device has received video signals during a predetermined time interval, or adjusts the current brightness value of the display device according to the calibration brightness value, under the condition that the calibration brightness value is not equal to zero and the display device has received the video signals during the predetermined time interval.

8. The electronic device according to claim 7, wherein the calculation module further determines the calibration brightness value to be zero and determines that there is no need to adjust the current brightness value of the display device, under the condition that the ambient brightness value is less than the predetermined value.

9. The electronic device according to claim 7, wherein the controlling module further shuts off a main circuit of the display device, under the condition that the display device has not received any video signals during the predetermined time interval.

10. The electronic device according to claim 7, wherein the one or more modules further comprises a setting module that sets operation modes of the display device, the operation modes comprise a factory mode, a testing mode, and a working mode.

11. The electronic device according to claim 10, wherein the controlling module further maintains the current brightness value of the display device, and continues receiving the electrical signals from the plurality of light sensors without adjusting the current brightness of the display device, under the condition that the calibration brightness value is not equal to zero and the display device is in the factory mode or the testing mode.

12. The electronic device according to claim 7, wherein the predetermined mapping function is
$$f ( x ) = \{ \begin{matrix}9.9323 Inx + 27.059 , x < 1254 \\ 100 , x \geq 1254.\end{matrix}$$

13. A non-transitory storage medium having stored instructions that, when executed by a microcontroller of a display device comprising a plurality of light sensors, causes the microcontroller to perform a method for adjusting brightness of the display device, the method comprising:
acquiring optical signals from the plurality of light sensors, the light sensors detecting the optical signals of a current environment of the display device;
converting the optical signals into digital signals;
determining an ambient brightness value of the display device according to the digital signals;
calculating a calibration brightness value of the display device corresponding to the ambient brightness value using a predetermined mapping function, under the condition that the ambient brightness value is not less than a predetermined value; and
maintaining a current brightness value of the display device under the condition that the calibration brightness value is equal to zero and the display device has received video signals during a predetermined time interval; or
adjusting the current brightness value of the display device according to the calibration brightness value, under the condition that the calibration brightness value is not equal to zero and the display device has received the video signals during the predetermined time interval.

14. The non-transitory storage medium according to claim 13, wherein the method further comprises:
determining the calibration brightness value to be zero and determining that there is no need to adjust the current brightness value of the display device, under the condition that the ambient brightness value is less than the predetermined value.

15. The non-transitory storage medium according to claim 13, wherein the method further comprises:
shutting off a main circuit of the display device, under the condition that the display device has not received any video signals during the predetermined time interval.

16. The non-transitory storage medium according to claim 13, wherein the method further comprises:
setting operation modes of the display device, the operation modes comprising a factory mode, a testing mode, and a working mode.

17. The non-transitory storage medium according to claim 16, wherein the method further comprises:
maintaining the current brightness value of the display device, and continuing receiving the electrical signals from the plurality of light sensors without adjusting the current brightness of the display device, under the condition that the calibration brightness value is not equal to zero and the display device is in the factory mode or the testing mode.

18. The non-transitory storage medium according to claim 13, wherein the predetermined mapping function is
$$f ( x ) = \{ \begin{matrix}9.9323 Inx + 27.059 , x < 1254 \\ 100 , x \geq 1254.\end{matrix}$$
